(19) United States
(12) Patent Application Publication
(10) Pub. No.: US 2004/0257305 A1
(43) Pub. Date: Dec. 23, 2004

(54) Plasma display with changeable modules

(76) Inventors: Jin-Wen Liao, Taipei (TW); Yet-Zen Lin, Taipei (TW)

Correspondence Address: GREENBERG TRAURIG LLP, 2450 COLORADO AVENUE, SUITE 400E, SANTA MONICA, CA, 90404, US

(21) Appl. No.: 10/813,480

(22) Filed: Mar. 29, 2004

Related U.S. Application Data
(60) Provisional application No. 60/458,304, filed on Mar. 28, 2003.

(30) Foreign Application Priority Data
Sep. 9, 2003 (TW) 092216293

(51) Int. Cl. G09G 3/28

(52) U.S. Cl. 345/60

(57) ABSTRACT

A plasma display for use in a particular region comprises an electronics board within a housing of the plasma display, at least one access slot to the electronics board from outside of the housing; and an at least one insertable module which mates with the electronics board through the at least one access slot, wherein the at least one insertable module is configured for a particular region and comprises at least one of a tuner, an extended audio and video connector, and a power supply.

### CROSS-REFERENCE TO RELATED APPLICATIONS

The contents of this application are related to U.S. Provisional Application No. 60/458,304 (filed Mar. 28, 2003) and to Taiwan Application No. 092216293 (filed Sep. 9, 2003) the contents of which are incorporated herein by reference in their entirety.

### BACKGROUND

1. Field of the Invention

This invention relates to flat displays, more particularly to flat panel plasma displays with a removable and changeable tuner, power and/or audio-video (i.e., A/V) modules which may be located in a separate bay.

2. Description of the Background Art

Because of their compact size and light weight combined with high quality video and/or television output, plasma displays have become well known and their use widespread throughout the world. A plasma display, designed for use in a specific geographical region, typically includes a tuner customized for the geographical region for receiving audio and video communications wirelessly, a power supply designed for that specific geographical region to deliver the appropriate current and voltage combination for operating the plasma display, an audio/video module for interfacing the audio and video signals from an external source (such as a computer) to the plasma display. These three components are generally hardwired on a single motherboard, having additional circuitry, in order to deliver the incoming audio and video signals to the loudspeakers and the plasma display screen respectively.

As is well known, the plasma display can be used as a monitor of computer or a screen of TV. The block diagram of a plasma TV system is as shown in FIG. 1, wherein it includes a tuner 110, an audio processor 120, a video decoder chip 130, a scaler 140, a plasma display panel 150, a speaker 170, and a power supply 160.

The tuner 110 receives a TV signal, and transfers the image parts to the video decoder chip 130 to generate a digital YCrCb and then converted to a video signal suitable for the plasma display panel 150 through the scaler 140 in order to drive the plasma display panel 150 to display the video signal. Besides, the voice parts are transferred to the audio processor 120 for converting to a suitable voice format to drive the horn 170. The power supply 160 supplies power to each IC and the entire system.

However, the tuner specifications for the plasma display, which is capable of television reception, vary from geographic region or country. For example, it is known that a display system may belong to one of NTSC, PAL, and SECAM standard. Also, a tuner in the NTSC system will be different from that in the SECAM system. Current methods of manufacturing a plasma display include a motherboard having the region specific tuner hardwired thereon.

Furthermore, very specific A/V connections, for use with a plasma display, are required in various geographic regions and/or countries. Current methods of manufacturing a plasma display utilize a motherboard with a region/country specific A/V connections hardwired thereon.

Furthermore, the power supply specifications for the plasma display vary from geographic region or country. For example, many European and Asian nations use a 230V/50 Hz power supply while other nations (such as the USA) use 110V/60 Hz power supply. Current methods of manufacturing a plasma display include a motherboard having a region specific power supply interface module hardwired thereon.

A major disadvantage of this hardwired design is that it is difficult for a consumer to operate a plasma display in a first region when the plasma display was purchased in a second region. Another disadvantage is that, it becomes extremely tedious and cost prohibitive for manufacturers to redesign motherboards for every geographical region due to the above types of differences.

### SUMMARY OF THE INVENTION

Since region specific changes in the design of a plasma display involve only changes to devices such as the tuner, the power supply and the A/V interface, and not to the motherboard, it is desirable to modularize these devices, to ensure reduced cost and complexity to the manufacturer and the adaptability of the plasma display to be used, by the consumer, in various regions with differing transmission, power supply, and connectivity standards.

Accordingly, in one exemplary implementation the plasma display uses a single motherboard and can support television reception in a region or country with a specific tuner requirement by using a changeable (viz., insertable) tuner module, wherein the removable tuner module is designed for that specific region.

Accordingly, in another exemplary implementation the plasma display uses a single motherboard and can support insertable/removable/changeable A/V input-output connections/connectors (e.g., of “110” type) configured for use with a specific A/V requirement by using a changeable or removable (viz., extended) A/V input-output interface module.

Accordingly, in yet another exemplary implementation plasma display uses a single motherboard and can support a insertable/removable/changeable power supply interface module designed for a region or country with a specific power requirement by using a changeable or removable power supply interface module, wherein the removable power supply interface module is designed for that specific region.

Accordingly, in yet another exemplary implementation, the extended audio-video connector module is configured for use with at least one of an S-video input, a component video input, a composite video input, an optical audio input, a coaxial audio input, and an RCA audio input.

In another exemplary implementation a circuit board assembly of a plasma display comprising a mother board and a plurality of separate daughter boards wherein the mother board is adapted to assemble with the daughter boards for making the mother board as a circuit board of the plasma display.

One exemplary implementation, provides a circuit board assembly of a plasma display, comprising a a mother board including (i) an audio decoder (ii) a video decoder, (iii) a connector interface for receiving at least one of an analog signal or a digital TV signal from an external source, (iv) an analog to digital converter for converting the at least one analog signal into an at least one digital signal, (v) a converter to convert the digital TV signal into a digital RGB signal, (vi) a scaler for reconverting the at least one digital signal into an at least one video signal, and (vii) a plasma display panel for receiving the at least one video signal from the scaler for displaying images thereon; a detachable/insertable/changeable power supply module for generating power to operate the motherboard, said power supply module being configured to operate at a power supply rating specific to a region where the plasma display is to be operated; an a detachable/insertable/changeable audio-video interface module comprising audio-video input-output connectors for receiving audio-video signals from the mother board or transmitting the same to the mother board; and a detachable/insertable/changeable tuner module for receiving the TV signal and transmitting the same to the audio-video decoder, wherein the tuner module is configured for operation in the region.

In another exemplary implementation a plasma display for use in a particular region comprises, (i) an electronics board within a housing of the plasma display, (ii) at least one access slot to the electronics board from the outside of the housing, and (iii) an at least one module which mates with the electronics board through the at least one slot, and wherein the at least one module is at least one of a tuner, an A/V connector and a power supply and wherein the at least one tuner, the A/V connector, and the power supply are designed for the particular region. An example of a region is one that employs at least one of a PAL or SECAM or an NTSC system. Another example of a region is one that employs specific power supply standards (e.g., the US region having 110V, 60 Hz or some Asian regions having 230V, 50 Hz).

### BRIEF DESCRIPTION OF THE DRAWINGS

FIG. 1 is a block diagram of a conventional circuit board of a plasma display;

FIG. 2 is a view depicting a motherboard and changeable or removable or insertable modules for a plasma display system according to an exemplary embodiment;

FIG. 3 is another view depicting a motherboard and changeable or removable or insertable modules for a plasma display system according to an exemplary embodiment;

FIG. 4 is a back view of a plasma display according to an exemplary embodiment;

FIG. 5 is a block diagram showing the changeable circuit board structure for the plasma TV according to an exemplary embodiment;

FIG. 6 is an exemplary depiction of a tuner circuit that can be used in the form of an insertable or removable module for the plasma display system.

It should be appreciated that for simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

### DESCRIPTION OF THE EMBODIMENTS

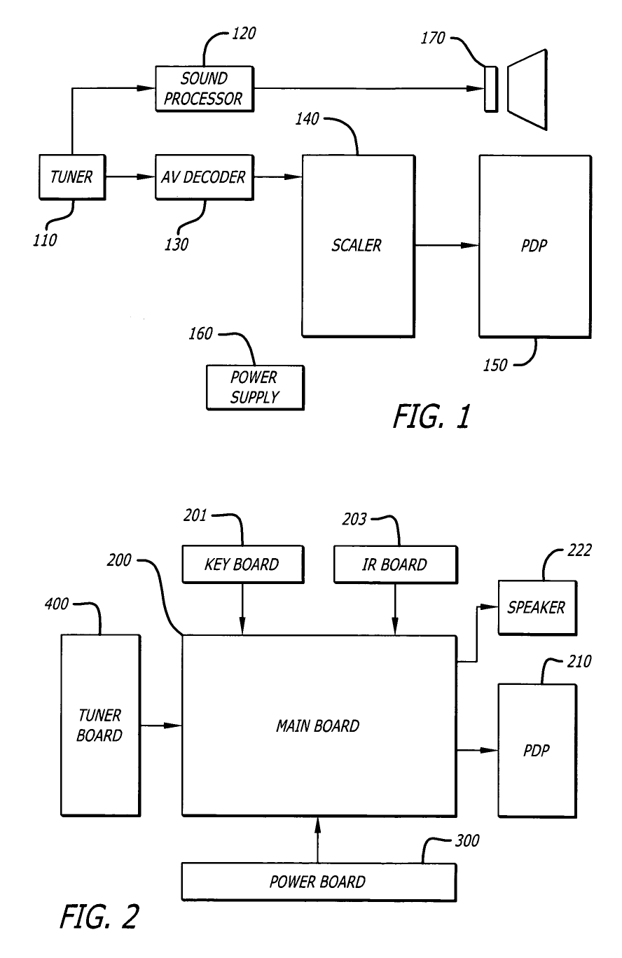

Detailed descriptions are disclosed herein; however, it is to be understood that the disclosed embodiments are merely exemplary of the invention, which may be embodied in various forms. Therefore, specific structural and functional details disclosed herein are not to be interpreted as limiting, but merely as a basis for claims and as a representative basis for teaching one skilled in the art to variously employ the present invention in virtually any appropriately detailed structure. Reference will now be made in detail to that disclosure which is illustrated in the accompanying drawing (FIGS. 1-6).

As is well known, the plasma display can be used as a monitor of computer or a screen of TV. The block diagram of a plasma TV system is as shown in FIG. 1, wherein it includes a tuner 110, an audio processor 120, a video decoder chip 130, a scaler 140, a plasma display panel 150, a speaker 170, and a power supply 160.

The tuner 110 receives a TV signal, and transfers the image parts to the video decoder chip 130 to generate a digital YCrCb and then converted to a video signal suitable for the plasma display panel 150 through the scaler 140 in order to drive the plasma display panel 150 to display the video signal. Besides, the voice parts are transferred to the audio processor 120 for converting to a suitable voice format to drive the horn 170. The power supply 160 supplies power to each IC and the entire system.

However, the tuner specifications for the plasma display, which is capable of television reception, vary from geographic region or country. For example, it is known that a display system may belong to one of NTSC, PAL, and SECAM standard. Also, a tuner in the NTSC system will be different from that in the SECAM system. Thus, the prior art embodiment of FIG. 1 shows a plasma display system that includes a motherboard having the region specific tuner hardwired thereon.

Furthermore, very specific A/V connections, for use with a flat plasma display, are required in various geographic regions and/or countries. The prior art embodiment of FIG. 1 will also utilize a motherboard with a region/country specific A/V connections hardwired thereon.

Furthermore, the power supply specifications for the plasma display vary from geographic region or country. For example, many European and Asian nations use a 230V/50 Hz power supply while other nations (such as the USA) use 110V/60 Hz power supply. The prior art embodiment of FIG. 1 will also include a motherboard having a region specific power supply interface module hardwired thereon.

A major disadvantage of this hardwired design is that it is difficult for a consumer to operate a plasma display in a first region when the plasma display was purchased in a second region. Another disadvantage is that, it becomes extremely tedious and cost prohibitive for manufacturers to redesign motherboards for every geographical region due to differences in (i) transmission standards (PAL/SECAM/NTSC), (ii) connectivity standards, and (iii) power supply standards.

Thus, one embodiment of the present system is directed to a motherboard of a plasma display that can receive changeable tuner modules, changeable power supplies and/or changeable A/V connectors. This manufacturing method eliminates the need for production of multiple motherboards for use in different regions/countries. This method and system can thus allow for configuring a display, for regions/country specific use, after production, thus simplifying the manufacturing process and the device.

Access to the motherboard for changing the tuner module and for A/V connections may be achieved by removing an external shroud of the device, or a bay. The bay may be open or covered. In any event a single motherboard is used for displays to be used in different regions/countries.

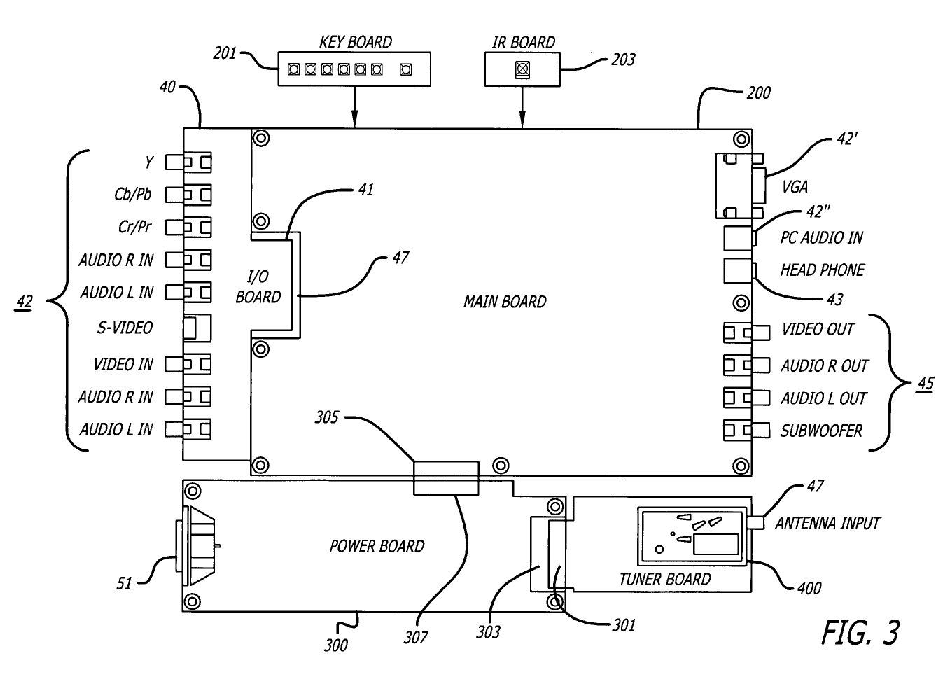

FIGS. 2 and 3 are views depicting a motherboard and changeable or removable or insertable modules for a plasma display system according to an exemplary embodiment. Specifically, shown therein are views depicting a motherboard or main board with changeable or removable or insertable tuner, a changeable or removable or insertable audio-video connector bank, and a changeable or removable or insertable power module for a plasma display system according to an exemplary embodiment. The motherboard 200, that is included within the casing of the plasma display system, provides the major electronic components to operate a plasma display panel connected thereto, and is also configured to accept one or more plug-in modules (viz., the tuner module 400, power supply module 300, and an A/V connector module 40). In this fashion a single motherboard 200 can be configured after production for use in different countries by utilizing changeable tuner module 400, changeable power supply module 300, and changeable A/V connector module 40. The power delivery from the power supply module 300 to the tuner module 400 is achieved by establishing connection between two connectors (viz., a female connector 303 in the power supply module 300 and a male connector 301 in the tuner module 400). Also, shown is an antenna 47, for receiving modulated TV signals, associated with the tuner module 400.

Similarly, the power delivery from the power supply module-300 to the motherboard 200 is achieved by establishing connection between two connectors (viz., a connector 307 in the power supply module 300 and another connector 305 in the motherboard 200). An input connector 51 on the power supply module 300 allows a user to connect a power supply (not shown) to the changeable power supply module 300 and in effect power the motherboard 200 and changeable tuner module 400. The changeable A/V connector module 40 includes different types of connectors such as SCART type, S-video, component video, composite video, coaxial audio, optical audio, RCA audio (shown generally by 42), PC audio in (shown as separate 42″ in the figure), and VGA (shown as separate 42′). The removable or changeable connector module 40 has a male type of a connector 41 which mates with a female connector 47 on the motherboard 200 to allow various input/out connectivity with the motherboard 200. Also shown in the figures, are keyboard 201 and infrared 203 input capabilities for the plasma display system, wherein the keyboard and infrared inputs are present in the motherboard 200. Furthermore, the video and audio outputs 45 from the motherboard may be delivered to external devices such as a monitor and a subwoofer. Also available is a headphone output 43 (which may be part of the changeable module 40) for delivering personal sound to a user.

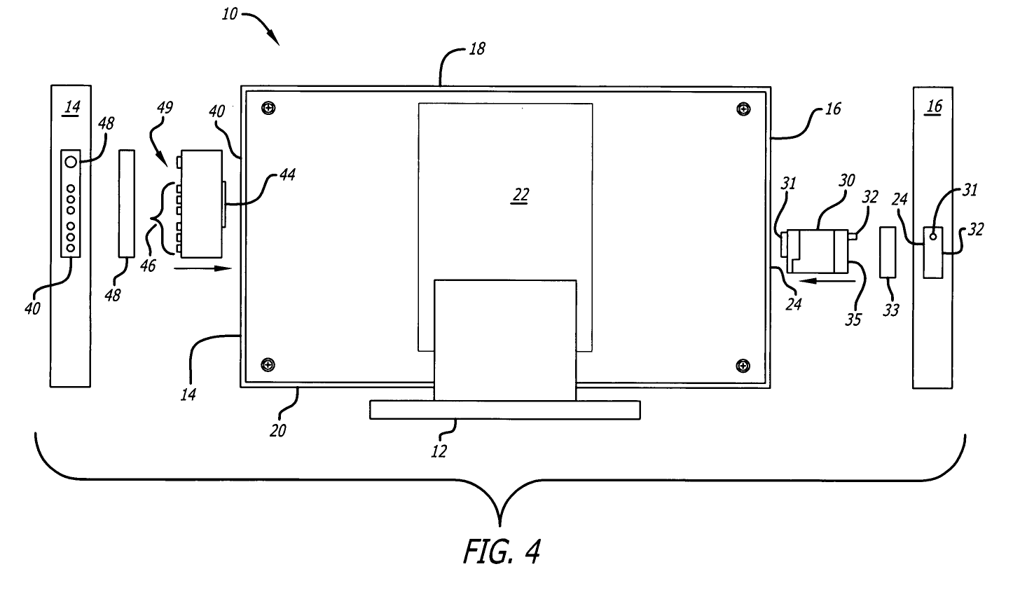

An exemplary embodiment of a back view of the plasma display system 10, with changeable modules, is shown in FIG. 4. The plasma display system 10 includes a casing 22 and has two sides 14 and 16, a top 18 and a bottom 20.

A tuner access slot 24 in the side 16 of the plasma display 10 provides access from the outside of the plasma display 10 to an internal area. The tuner module 30, which is separate and external to the motherboard and which provides for television reception in accordance with pre-selected country, or region specific specifications, mates through the tuner access slot 24 into a motherboard (not shown in this figure). The tuner module 30 also may include a tuner plug in jack 31 to mate with the motherboard. The tuner module may further include an input jack 32 which is accessible from the outside of the flat plasma display 10. A tuner cover 33 may be fitted over the end of the tuner 35 and tuner access slot 24.

An A/V access slot 40 in the side 14 of the plasma display 10 provides access from the outside of the plasma display 10 to an internal area. The A/V module 42, which is separate and external to the motherboard and which provides for A/V input/output in accordance with pre-selected country, or region specific specifications, mates through the A/V access slot 40 into a motherboard (not shown in this figure). The A/V module 42 has an A/V plug in jack 44 to mate with the motherboard. The A/V module has input/output jacks 46 (e.g., component video, composite video, S-video, coaxial audio, optical audio, RCA audio) which are accessible from the outside of the plasma display 10. An A/V cover 48 can be fitted over the end of the A/V module 49 and A/V access slot 40.

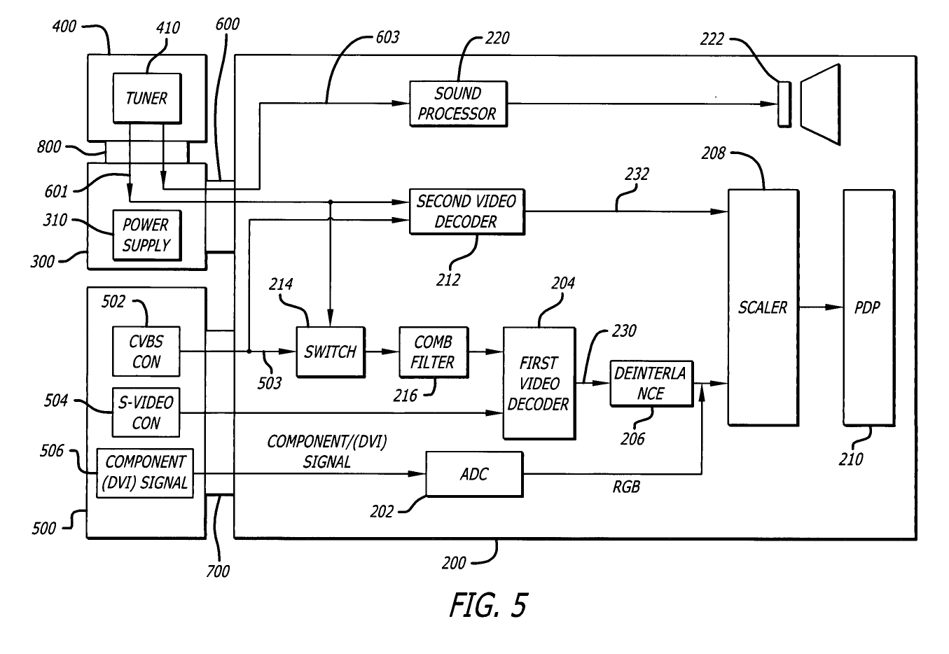

With reference to FIG. 5, shown therein is the changeable modular structure for the plasma display according to an exemplary embodiment, which includes a main board 200, a removable or insertable or changeable power supply module 300, a removable or insertable or changeable tuner module 400, and a removable or insertable or changeable extended audio-video input/output sub-board 500.

The main board 200 has an analog-digital converter 202, a first video decoder chip 204, a deinterlacer 206, a scaler 208, a plasma display panel 210, a second video decoder chip 212, a switch 214, a comb filter 216, a speaker 222, and an audio processor 220.

The insertable/changeable extended audio-video input/output sub-board 500 has various specifications of input/output connectors, such as S-video connector 504, CVBS connector (Composite video connector) 502, DVI (not shown, and component signal connector 506, in order to receive or output various specifications of video signal while inserted to the main board 200. The extended audio-video input/output sub-board 500 electrically connects to the main board 200 through a connecting element shown as 700.

When the removable/insertable/changeable audio-video input/output sub-board 500 connects to the main board 200, the main board 200 may receive an analog component signal from the component signal connector 506 of the audio-video input/output sub-board 500. The analog component signal is converted to a digital RGB signal by the converter 202. After the digital RGB signal is converted to a video signal, by the scaler 208, the plasma display panel 210 can display the component video signal.

When the extended audio-video input/output sub-board 500 connects to the main board 200, the main board 200 may also receive a CVBS TV signal from the CVBS connector 502 of the extended audio-video input/output sub-board 500. The CVBS TV signal is then delivered to the switch 214 via the connecting element 503.

The insertable tuner sub-board 400 comprising a tuner 410 delivers the received TV signal to the switch 214 via 601 and to the sound processor via 603. The switch 214 could (i) selectively output either the CVBS TV signal or the TV signal from the tuner sub-board 400, and (ii) filter the output signal to remove the noise signal.

The output of the comb filter 216 couples to the first video decoder chip 204 in order to generate a first digital YUV (i.e., Y′CbCr/YpbPr) signal 230. The deinterlacer 206 converts the digital YUV signal format to a progressive digital RGB signal format. Furthermore, the progressive digital RGB signal is converted to a video signal by the scaler 208 suitable for display by plasma display panel 210.

An input connector of the second video decoder chip 212 receives a TV signal via the tuner sub-board 400, and another connector receives a CVBS TV signal from the CVBS connector 502 of the extended audio-video input/output sub-board 500. The second video decoder chip 212 decodes the CVBS TV signal or the TV signal from the tuner sub-board 400 to generate a second digital YUV signal 232. The YUV signal 232 is converted to a video signal suitable for the plasma display panel 210, through the scaler 208, in order to form a PIP (picture-in-picture) image with the progressive digital RGB signal from the deinterlacer 206. Specifically, the second digital YUV signal 232, generated by the second video decoder chip 212, provides the overlay image (i.e., the small image), and the progressive digital RGB signal generated by the deinterlacer 206 provides the background image (i.e. the main image) due to the high quality.

The removable power supply 310 on the power supply sub-board 300 supplies power to the main board 200 and electrically connects to the main board 200 via a connecting element 600. Furthermore, the power supply sub-board 300 and the tuner sub-board 400 are electrically connected via 800. Thus, each sub-board (viz., the power supply board, the tuner board, and the audio-video board) may be selectively inserted to the main board depending on the regional requirements.

The connecting elements 700, 800, and 600 could be a pair of male-female connectors, pins and corresponding connecting slot, or a cable and corresponding adapter base. By any of the aforementioned connecting elements, different kind of sub-boards (i.e., the power supply sub-board 300, the tuner sub-board 400, and the extended audio-video input/output sub-board 500) could connect to the main board 200 depending on various production demands.

In the present embodiment, the appropriate combination of the main board 200, the power supply sub-board 300, and the tuner sub-board 400 can make the plasma TV function work in any region. The need for inputting various types of video formats to the plasma TV can be achieved by connecting the extended audio-video input/output sub-board 500 to the main board via the connecting element 700.

Also, the audio-video input/output sub-board 500 may include different types of connectors such as VGA, SCART type, S-video, DVI, component video, composite video, coaxial audio, optical audio, and RCA audio.

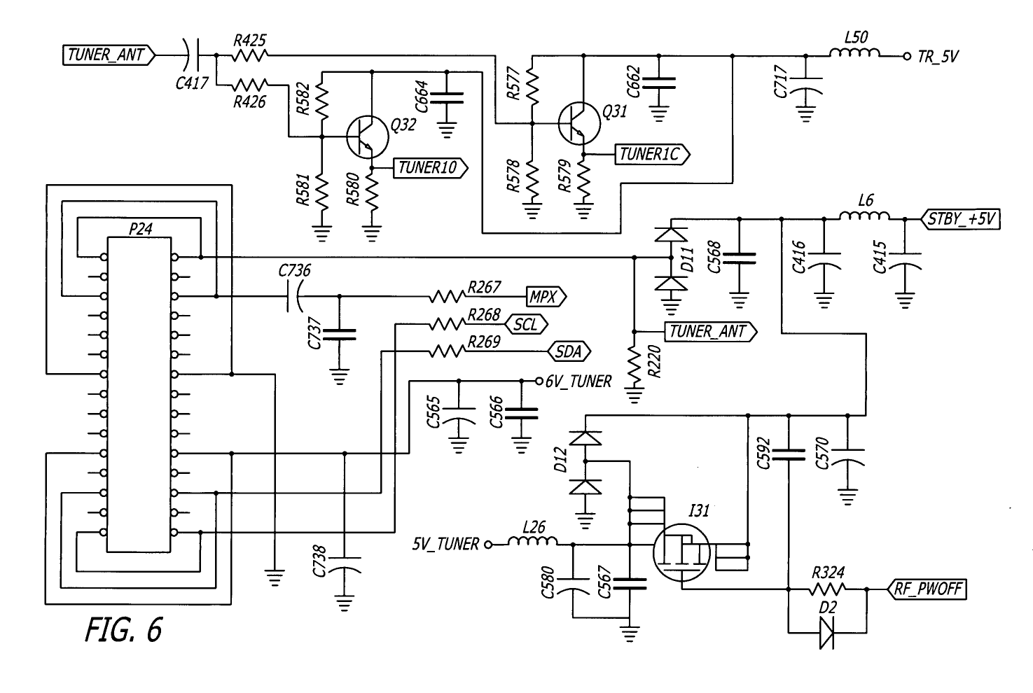

FIG. 6 is an exemplary depiction of a tuner circuit that can be used in the form of an insertable or removable module for the plasma display system. Examples of tuner IC chips that can be used in the tuner module is the Phillips FL1236N or the FQ1236 which provides channel coverage in 3 bands: (i) Low band (between 55.25 and 16 MHz), (ii) Mid band (between 160 and 442 MHz), and (iii) High band (between 442 and 801.25 MHz).

It is to be understood that other embodiments may be utilized and structural and functional changes may be made without departing from the respective scope of the present invention. Possible modifications to the system include, but are not limited to, design of different mating connections between the tuner module, the power supply module, the A/V connector module with the motherboard. Also, the plasma display panel may be modular in that different types of panels having different features/quality may be removed and added to the plasma display system as needed.

We claim:

1. A plasma display for use in a particular region comprising:
an electronics board within a housing of the plasma display;
at least one access slot to the electronics board from outside of the housing; and
an at least one insertable module which mates with the electronics board through the at least one access slot;
wherein the at least one insertable module is configured for a particular region and comprises at least one of a tuner, an extended audio and video connector, and a power supply.

2. The plasma display according to claim 1 wherein the tuner module is configured for use in a region having a PAL video standard.

3. The plasma display according to claim 1 wherein the tuner module is configured for use in a region having a SECAM video standard.

4. The plasma display according to claim 1 wherein the tuner module is configured for use in a region having an NTSC video standard.

5. The plasma display according to claim 1 wherein the power supply module is configured for use in a region having a 230 V AC and 50 Hz power transmission standard.

6. The plasma display according to claim 1 wherein the power supply module is configured for use in a region having a 110 V AC and 60 Hz power transmission standard.

7. The plasma display according to claim 1 wherein the extended audio-video connector module is configured for use with at least one of an S-video input, a VGA input, a SCART input, a component video input, a composite video input, an optical audio input, a coaxial audio input, and an RCA audio input.

8. The plasma display according to claim 1 wherein the extended audio-video connector module is configured for use with at least one of an video output, an RCA audio output, a subwoofer output.

9. A circuit board assembly of a plasma display, comprising:
a mother board including (i) an audio decoder (ii) a video decoder, (iii) a connector interface for receiving at least one of an analog signal or a digital TV signal from an external source, (iv) an analog to digital converter for converting the at least one analog signal into an at least one digital signal, (v) a converter to convert the digital TV signal into a digital RGB signal, (vi) a scaler for reconverting the at least one digital signal into an at least one video signal, and (vii) a plasma display panel for receiving the at least one video signal from the scaler for displaying images thereon;
an insertable power supply module for generating power to operate the motherboard, said power supply module being configured to operate at a power supply rating specific to a region where the plasma display is to be operated;
an insertable audio-video interface module comprising audio-video input-output connectors for receiving audio-video signals from the mother board or transmitting the same to the mother board; and
an insertable tuner module for receiving the TV signal and transmitting the same to the audio-video decode, wherein the tuner module is configured for operation in a preselected region or regions.

10. The circuit board assembly of claim 9 wherein the external source is a computer.

11. The circuit board assembly of claim 9 wherein the external source is a video game console system.

12. The circuit board assembly of claim 9 wherein the external source is a a DVD player capable of outputting a digital DVI signal.
